(19) United States
(12) Patent Application Publication
(10) Pub. No.: US 2012/0081254 A1
(43) Pub. Date: Apr. 5, 2012

(54) ANTENNA DEVICE FOR PORTABLE TERMINAL

(75) Inventor: Jin-Seok MOON, Suwon-si (KR)

(73) Assignee: SAMSUNG ELECTRONICS CO. LTD., Suwon-si (KR)

(21) Appl. No.: 13/219,970

(22) Filed: Aug. 29, 2011

(30) Foreign Application Priority Data
Oct. 5, 2010 (KR) 10-2010-0096741

(51) Int. Cl. H01Q 3/24; H01Q 1/00

(52) U.S. Cl. 343/720; 343/876

(57) ABSTRACT

An antenna device of a portable terminal is provided. The device includes a sensor, at least two antenna radiators, and a controller. The sensor detects rotation of the portable terminal. At least two antenna radiators radiate radio waves. A controller selects one of the antenna radiators according to a rotation signal detected by the sensor, and switches on the selected antenna radiator so that the selected antenna radiator radiates radio waves.

### PRIORITY

This application claims the benefit under 35 U.S.C. §119(a) of a Korean patent application filed in the Korean Intellectual Property Office on Oct. 5, 2010 and assigned Serial No. 10-2010-0096741, the entire disclosure of which is hereby incorporated by reference.

### BACKGROUND OF THE INVENTION

1. Field of the Invention

The present invention relates to an antenna device. More particularly, the present invention relates to an antenna device for a portable terminal that may selectively change an antenna radiator for radiating a radio wave.

2. Description of the Related Art

As the electronic communication industry continues to develop and produce advanced portable terminals, such as an electronic scheduler, a personal digital assistant, etc., these devices have become indispensable to modern society and play a role as an important means for quickly transferring information. Under these circumstances, portable terminals continue to advance to provide even more advanced functions and to have a light weight and a slim profile.

As a terminal provides additional and advanced functions, it becomes difficult to mount the necessary elements for the various multi-functions while maintaining a light weight and a slim profile. For example, a case frame defining an outer surface of the portable terminal limits a space in which the necessary elements are mounted.

Generally, the portable terminal has an antenna device for communication. The antenna device includes an antenna radiator that transmits and receives radio signals. It is known that an antenna performance improves when the antenna radiator is large. However, as descried above, it is difficult to realize a large antenna radiator with consideration of other elements in a limited space. Furthermore, the radiation performance of the antenna device may increase or decrease depending on the way in which the user grips the portable terminal For example, when the user's hand that grips the portable terminal is close to the antenna radiator, the radiation performance of the antenna device may deteriorate. Accordingly, there is a need for an antenna device that improves radiation performance of a portable terminal

### SUMMARY OF THE INVENTION

Aspects of the present invention are to address at least the above-mentioned problems and/or disadvantages and to provide at least the advantages described below. Accordingly, an aspect of the present invention is to provide an antenna device for improving an antenna radiation performance of a portable terminal.

Another aspect of the present invention is to provide an antenna device that changes to an antenna radiator capable of securing a radiation performance depending on a position at which a user grips the portable terminal

Still another aspect of the present invention is to provide an antenna device of a portable terminal that changes an antenna radiator depending on rotation of the portable terminal

In accordance with an aspect of the present invention, an antenna device for a portable terminal is provided. The antenna device includes a sensor for detecting rotation of the portable terminal, at least two antenna radiators for radiating radio waves, and a controller for selecting one of the antenna radiators depending on a rotation signal detected by the sensor, and for switching on the selected antenna radiator so that the selected antenna radiator radiates radio waves.

In accordance with other aspect of the present invention, an antenna device of a portable terminal having a display unit for outputting image data to a screen is provided. The antenna device includes a sensor for detecting rotation of the portable terminal, at least two antenna radiators for radiating radio waves, and a controller for pivoting the screen to provide one of a horizontal view and a vertical view depending on a rotation signal detected by the sensor, and for selecting and switching on an antenna radiator positioned at one of an upper side and a lower side of the pivoted screen so that the selected antenna radiator radiates radio waves.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a perspective view illustrating a portable terminal according to an exemplary embodiment of the present invention;

FIG. 2 is a block diagram illustrating an antenna device of a portable terminal according to an exemplary embodiment of the present invention; and

FIG. 3 is a schematic view illustrating an operation of an antenna device according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

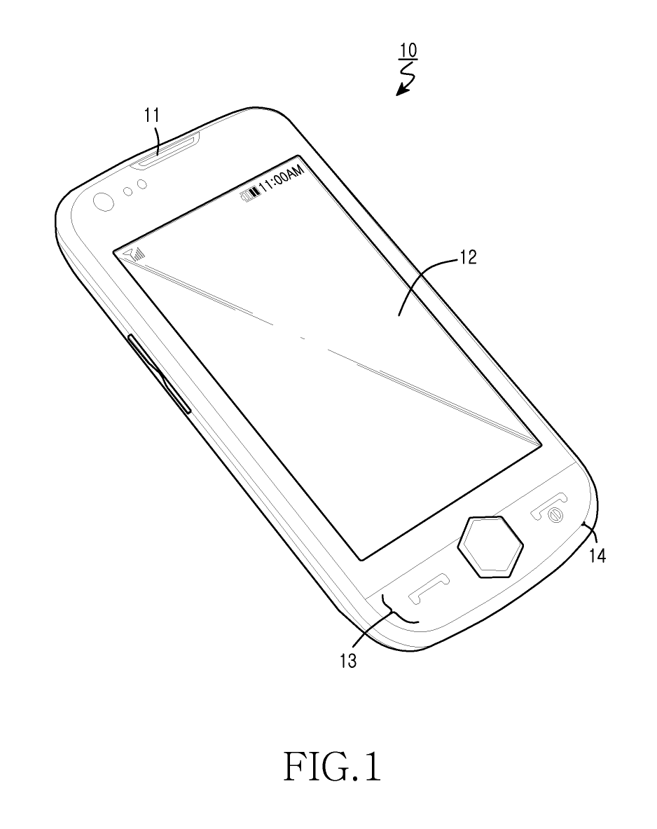

FIGS. 1 through 3, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

Exemplary embodiments of the present invention provide an antenna device. More particularly, exemplary embodiments of the present invention provide an antenna device of a portable terminal that may selectively change an antenna radiator for radiating radio waves.

FIG. 1 is a perspective view illustrating a portable terminal according to an exemplary embodiment of the present invention.

Referring to FIG. 1, the portable terminal 10 includes a speaker 11 for outputting an audio signal such as a voice signal, and a display 12, positioned below the speaker, for outputting a video signal. Furthermore, the portable terminal 10 includes a keypad assembly 13 that serves as a data input unit, and a microphone 14 positioned below the keypad assembly 13, for receiving an audio signal such as a voice signal. The display 12 may be a Liquid Crystal Display (LCD) having millions of pixels. In addition, in the case where a touch screen is provided with the LCD, the display 12 may perform the function of a data input unit as an auxiliary unit or in substitution for the keypad assembly 13.

More particularly, the portable terminal 10 includes an antenna device (shown and described below) for transmitting/receiving radio signals. The antenna device according to an exemplary embodiment of the present invention has at least two antenna radiators for radiating radio waves, and may selectively use a suitable antenna radiator that can secure a radiation performance depending on a rotation state of the portable terminal

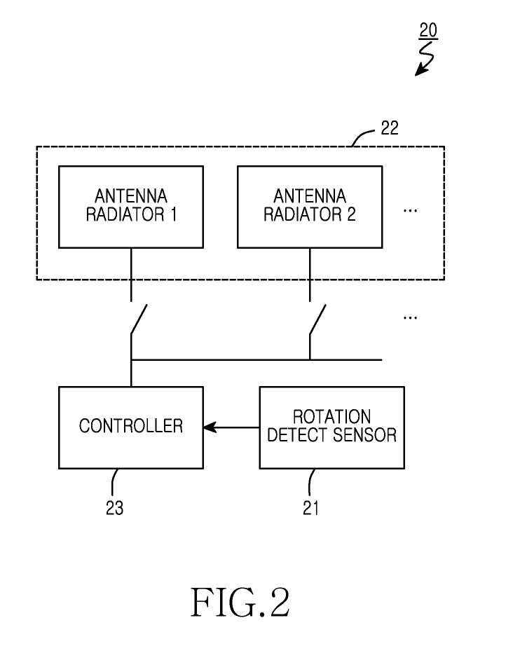

FIG. 2 is a block diagram illustrating an antenna device of a portable terminal according to an exemplary embodiment of the present invention.

Referring to FIG. 2, the antenna device 20 of the portable terminal includes a rotation detect sensor 21 for detecting a rotation of the portable terminal, at least two antenna radiators 22 for radiating radio waves, and a controller 23 for selecting one of the antenna radiators depending on a signal regarding the rotation detected by the sensor, and for switching on the selected antenna radiator so that the selected antenna radiator may radiate radio waves.

When switched on by the controller 23, the antenna radiators 22 may be fed from the controller 23 or a feed power source and may radiate radio waves. The antenna radiators 22 not switched on by the controller 23 cannot radiate radio waves. According to an exemplary embodiment of the present invention, the antenna radiators 22 may be located at one or more of the upper side, the lower side, the left side, and the right side of the portable terminal. Furthermore, the antenna radiators 22 may each include an insulation carrier and a metal plate attached on the insulation carrier. More specifically, the insulation carrier may be provided to electrically isolate the metal plate, which is provided for radiating radio waves, from other electrically conductive components of the portable terminal

The rotation detect sensor 21 detects that the portable terminal rotates clockwise or counterclockwise and outputs a rotation signal thereof The rotation signal varies depending on a rotation angle. In an exemplary implementation, the rotation detect sensor 21 for detecting the rotation includes one of an acceleration sensor and a gyro sensor.

The controller 23 may determine how the portable terminal has rotated using a rotation signal provided by the rotation detect sensor 21. According to an exemplary embodiment of the present invention, the controller 23 may determine that the portable terminal is oriented vertically or horizontally depending on the rotation signal via an algorithm.

In the case where the portable terminal is oriented vertically or horizontally, the controller 23 selects and switches on a relevant antenna radiator provided to the portable terminal. Generally, a user handles the portable terminal oriented either vertically or horizontally in left and right direction. Therefore, it is advantageous in securing a radiation performance to use an antenna radiator spaced apart from a gripped portion.

In addition, the portable terminal generally has a display unit having a screen of a horizontal or vertical orientation that outputs image data. In an aspect of an exemplary embodiment of the present invention, the screen of the display unit may be pivoted depending on a rotation signal provided by the rotation detect sensor 21. That is, in the case where the portable terminal is oriented from the vertical direction to the horizontal direction, the controller 23 changes the screen from a vertical view to a horizontal view. Furthermore, the controller 23 switches on an antenna radiator on the upper side and/or the lower side of the screen.

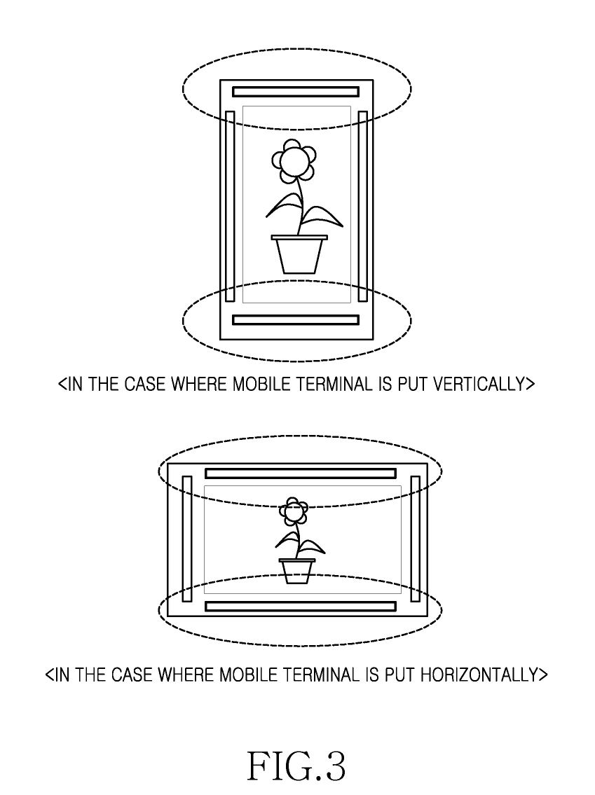

FIG. 3 is a schematic view illustrating an operation of an antenna device according to an exemplary embodiment of the present invention.

Referring to FIG. 3, when the portable terminal is oriented horizontally, the antenna device according to an exemplary embodiment of the present invention uses an antenna radiator on the upper side and/or lower side positioned at the portion shown by a broken line. The use of an antenna radiator on the upper side and/or lower side when the portable terminal is oriented horizontally is beneficial because, in that position, a user typically grips the device on the left side and the right side. In addition, when the portable terminal is oriented vertically, the antenna device according to an exemplary embodiment of the present invention uses an antenna radiator on the left and/or right side positioned at the portion shown by a dotted line. Similarly, the use of an antenna radiator on the left side and/or right side when the portable terminal is oriented vertically is beneficial because, in that position, a user typically grips the device on the upper side and the lower side.

Consequently, the antenna device of the portable terminal according to an exemplary embodiment of the present invention selectively uses an antenna radiator that may secure a radiation performance depending on a circumstance where the portable terminal is oriented horizontally or vertically, so that the radiation performance is not deteriorated.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An antenna device for a portable terminal, the device comprising:
a sensor for detecting rotation of the portable terminal;
at least two antenna radiators for radiating radio waves; and
a controller for selecting one of the antenna radiators depending on a rotation signal detected by the sensor, and for switching on the selected antenna radiator so that the selected antenna radiator radiates radio waves.

2. The device of claim 1, wherein the controller determines whether the portable terminal is oriented vertically or horizontally depending on the rotation signal.

3. The device of claim 2, wherein the controller selects and switches on an antenna radiator positioned at one of an upper side, a lower side, a right side, and a left side of the portable terminal oriented vertically or horizontally.

4. The device of claim 1, wherein the sensor for detecting the rotation comprises at least one of an acceleration sensor and a gyro sensor.

5. The device of claim 1, wherein the at least two antenna radiators are located on an inner surface of a case frame of the portable terminal

6. The device of claim 1, wherein the at least two antenna radiators comprise:
an insulation carrier; and
a metal plate attached on the insulation carrier.

7. The device of claim 1, wherein the antenna radiators are located on at least one of an upper side, a lower side, a left side, and a right side of the portable terminal

8. The device of claim 1, wherein the portable terminal comprises a display unit for outputting image data on a screen, and the antenna radiators are located on at least one of an upper side, a lower side, a left side, and a right side of the screen.

9. The device of claim 8, wherein the controller pivots the screen to provide one of a horizontal view and a vertical view depending on the rotation signal, and switches on an antenna radiator positioned at one of the upper side, the lower side, the left side, and the right side of the pivoted screen.

10. An antenna device of a portable terminal having a display unit for outputting image data to a screen, the device comprising:
a sensor for detecting rotation of the portable terminal;
at least two antenna radiators for radiating radio waves; and
a controller for pivoting the screen to provide one of a horizontal view and a vertical view depending on a rotation signal detected by the sensor, and for selecting and switching on an antenna radiator positioned at one of an upper side and a lower side of the pivoted screen so that the selected antenna radiator radiates radio waves.

11. The device of claim 10, wherein the sensor for detecting the rotation comprises one of an acceleration sensor and a gyro sensor.

12. The device of claim 10, wherein the antenna radiators are located on at least one of an upper side, a lower side, a left side, and a right side of the screen.

13. The device of claim 10, wherein the at least two antenna radiators are located on an inner surface of a case frame of the portable terminal

14. The device of claim 10, wherein the at least two antenna radiators comprise:
an insulation carrier; and
a metal plate attached on the insulation carrier.

15. The device of claim 10, wherein the antenna radiators are located on at least one of an upper side, a lower side, a left side, and a right side of the portable terminal.

16. An antenna device of a portable terminal, the device comprising:
a sensor for detecting rotation of the portable terminal;
at least two antenna radiators for radiating radio waves; and
a controller for pivoting the screen to provide one of a horizontal view and a vertical view depending on a rotation signal detected by the sensor, and for selecting and switching on an antenna radiator positioned at one of an upper side and a lower side of the pivoted screen so that the selected antenna radiator radiates radio waves.

17. The device of claim 16, further comprising a display unit for outputting image data on the screen, and the antenna radiators are located on at least one of an upper side, a lower side, a left side, and a right side of the screen.

18. The device of claim 16, wherein the at least two antenna radiators comprise:
an insulation carrier; and
a metal plate attached on the insulation carrier.

19. The device of claim 16, wherein the antenna radiators are located on at least one of an upper side, a lower side, a left side, and a right side of the portable terminal

20. The device of claim 16, wherein the at least two antenna radiators are located on an inner surface of a case frame of the portable terminal
